(19) United States
(12) Patent Application Publication
(10) Pub. No.: US 2014/0260189 A1
(43) Pub. Date: Sep. 18, 2014

(54) FORCED INDUCTION SYSTEM WITH REGENERATIVE CHARGE AIR CONTROL

(71) Applicant: Desen Corporation, Mississauga (CA)

(72) Inventors: Darryl Sendrea, Sendrea (CA); Joseph M. Jenkins, Cambridge (CA)

(73) Assignee: Desen Corporation, Mississauga (CA)

(21) Appl. No.: 14/213,117

(22) Filed: Mar. 14, 2014

Related U.S. Application Data
(60) Provisional application No. 61/791,876, filed on Mar. 15, 2013.

(51) Int. Cl. F02B 37/14

(52) U.S. Cl. CPC F02B 37/14
USPC 60/273

(57) ABSTRACT

An internal combustion engine forced induction system and a method for operating the same. The turbocharged engine has an electronic control module and operating instructions in memory. The system includes a modified forced induction system that captures and stores air from the induction system via a system of valves and releases the stored air back into the intake system during acceleration so that turbo response lag is reduced or greatly ameliorated. Regenerative braking is further disclosed to capture and store air for release to the intake system. A method for controlling the forced induction system is also disclosed. Furthermore, a method for controlling the exhaust flow away from the exhaust stream upstream of the turbocharger and into an auxiliary storage tank and back into the exhaust stream upstream of the turbocharger; assisting the pre-spool of the turbine to further or also reduce turbo response lag.

### TECHNICAL FIELD

Conventional automotive forced induction systems comprise either an exhaust driven turbocharger or an engine driven supercharger to compress incoming air into the intake system of a typical internal combustion engine. Compressing the intake air results in an increase in air volume being processed through the engine, therefore resulting in increased engine power. The ability to sustain elevated boost levels across the beneficial engine revolution range is largely governed by the size and operating efficiency of the turbocharger(s) and the induction system as well as the emissions control system methodology. One drawback to utilizing an exhaust-driven turbocharger is a characteristic called “turbo lag” which essentially is the time required for the turbocharger to reach the optimal rotation speed for the peak efficiency necessary in generating sustainable boost levels. This turbo lag characteristic appears every time the turbocharger rotation speed is reduced and then increased again and it is directly proportional to the throttle position. During transmission shift events, the engine speed may be reduced and increased again by throttling the engine down and up again. In doing so, the turbocharger is slowed down by the control system and allowed to spool back up during acceleration. In such an event, the engine intake system charge air would also be expelled to the turbocharger inlet or to the atmosphere. During shifting and with the throttle completely closed, the engine intake system would undergo a momentary vacuum situation prior to re-acceleration. During acceleration, the control system would therefore allow the turbocharger to begin its boost cycle again. Since turbo lag is introduced at the start of each boost cycle include, there could be a momentary loss of engine performance between deceleration and acceleration events, as well as a delay in restoring performance. This loss in performance is directly attributable to the transient nature of the induction charge pressure.

There is an opportunity to improve a forced induction system by capturing and storing the induction charge via a controlled blow-off valve during deceleration and releasing it back into the intake stream during acceleration.

### SUMMARY

In one embodiment, there is disclosed an internal combustion engine forced induction system and a method for operating the same. The engine may be a compression or ignition engine, such as diesel or gasoline engines, respectively, which may be electronically controlled or have an electronic control module for controlling the exhaust system of such an engine. In another embodiment, it is contemplated to use regenerative braking to charge an auxiliary tank with air and use it to create the induction charge. There is disclosed a modified forced induction system that captures and stores air from the induction system via a system of valves and releases the stored air back into the intake system during acceleration so that turbo lag is reduced or greatly ameliorated. A method for controlling the forced induction system is also disclosed, which comprises the steps of determining engine speed, determining mass air flow or manifold pressure; determining turbo speed; diverting at least a portion of the air flow to an induction system when mass air or manifold pressure exceeds a predetermined value; determining whether engine speed is below a predetermined level; determining when mass air flow or manifold pressure is below a predetermined level; determining when turbocharger speed is below a predetermined level; releasing air from the induction system into the manifold until turbo charger speed and mass air flow or manifold pressure are within predetermined levels during acceleration of an engine.

### BRIEF DESCRIPTION OF THE DRAWINGS

FIG. 1 is a schematic representation of an electronically controlled internal combustion engine with an air induction system.

FIG. 2 is a schematic representation of a perspective view of the system of FIG. 1.

FIG. 3 is a schematic representation of one method of operation of one embodiment of the disclosure.

FIG. 4 is a schematic representation of one aspect of operation, schematically representing the various actions of the engine components based upon throttle position.

### DETAILED DESCRIPTION

Turning now to the numbers wherein like numbers refer to like structures, FIG. 1 is a schematic representation of an electronically controlled internal combustion engine with an air induction system 10 according to one embodiment of the disclosure. In one embodiment, the system 10 includes a central processing unit 58, an optional regenerative braking air compressor 14, a compressed air storage tank 16, and stored charge control valves 18 and 20, respectively. The engine 22, shown as an internal combustion engine, is in fluid communication through exhaust conduit 24 to the exhaust storage tank 26a or optionally 26b. The engine is in fluid communication through air inlet conduit 28 to an air inlet 30 via a turbocharger unit 32. A wastegate 34 is in the exhaust conduit 24 between the engine and the turbocharger to divert exhaust gas to and from the exhaust storage tank 26a or optionally 26b, respectively, as is known in the art. The turbocharger is in fluid communication with the exhaust system 36, through exhaust conduit 38. The turbocharger is further in fluid communication with the compressed air tank via conduit 40. Conduit 40 has a stored charge control valve 42 on a turbocharger side, and connects the turbocharger to the intercooler 44. The intake system including the intercooler 44 is in fluid connection with the storage tank via the bypass air system 46. The bypass air system is equipped with an air bypass control valve 48 to bypass air intake to the engine while an air charge is stored in the intake tube 50. Similarly, the regenerative brake system 14 is in fluid communication to the storage tank (or optionally, an auxiliary storage tank) via conduit 52. Conduit 52 is equipped with a stored charge control valve 54. The storage conduit valve 54 is responsive to signals from the controller to permit air generated from the regenerative brake system to be stored in the storage (or auxiliary storage) tank, as needed. Throttle 56 is in fluid communication with the intake tube 50, and in conjunction with the engine, is controlled by an electronic controller 58.

The engine is operated in accordance with instructions in controller 58, such as an electronic control module or engine control module. The controller, which may be one or more modules, has a memory which may be RAM, ROM, DRAM, PROM, EPROM, EEPROM, FLASH or any other volatile or non volatile memory within which resides tables or maps populated by various values or instructions for operating the engine and its various components. The controller is in communication with the engine, sensors and engine components over an ECAN link 60. The operating instructions are accessed to control various operations of the engine and other system or subsystems associated therewith, such as, for example the sensors in the exhaust, EGR, turbocharger, intake systems, fuel injectors, fuel pump, fuel system pressure regulator, fueling strategy, timing and ignition control components. For example, the controller may include fueling maps or tables as well as timing instructions for controlling the engine during various operating conditions. These fueling maps or tables and timing strategies may be pre-programmed or programmable.

The controller may also include a microprocessor unit in communication with various computer readable storage media via a data and control bus. The computer readable storage media may include any of a number of known devices which function as read only memory, random access memory, and non-volatile random access memory. A data, diagnostics, and programming input and output device may also be selectively connected to the controller via a plug to exchange various information therebetween. Values within the computer readable storage media, such as configuration settings, calibration variables, instructions for EGR, intake, and exhaust systems control, turbocharger set speeds and others may be changed with PC type service tools as is known in the art.

Various sensors may be in electrical communication with the controller via input/output ports. The controller may include a microprocessor unit in communication with various computer readable storage media via a data and control bus. The computer readable storage media may include any of a number of known devices which function as read only memory, random access memory, and non-volatile random access memory. A data, diagnostics, and programming input and output device may also be selectively connected to the controller via a plug to exchange information there between. Values within the computer readable storage media, such as configuration settings, calibration variables, instructions for EGR, intake, and exhaust systems control, turbocharger set speeds and others may be changed with PC type service tools as is known in the art.

In operation, the controller receives signals from various engine/vehicle sensors and executes control logic embedded in hardware and/or software to control the system. The computer readable storage media may, for example, include instructions stored thereon that are executable by the controller to perform methods of controlling all features and sub-systems in the system. The program instructions may be executed by the controller to control the various systems and subsystems of the engine and/or vehicle through the input/output ports. Furthermore, it is appreciated that any number of sensors and features may be associated with each feature in the system for monitoring and controlling the operation thereof.

FIG. 2 is a perspective view of the system depicted in FIG. 1, showing exhaust flow 11 and the regenerative brake system in greater detail.

Specifically, Regenerative Braking Air Compressor 14 may be driven by a gear arrangement 62 or by a belt driven drive arrangement 64, or by any other arrangement to transfer the energy lost during braking events to the compressor and thereby transfer pressurized air to the storage tank or an auxiliary storage tank for use during need when boost is required or turbo lag occurs.

FIG. 3 is a schematic representation of a method 66 according to one embodiment of the present disclosure. Specifically step 68 is normal operation of the engine. During the operation of the engine, an acceleration request is made by the operator, and is indicated by a change in throttle demand. The change in throttle demand generally indicates the throttle is opened or closed, responsive to the operation of the engine. A number of events occur in the system during throttle demand, as will be described in relation to FIG. 4.

Returning to FIG. 3, as throttle demand is met, step 70 is determining whether the engine speed is above a predetermined level. Generally, when an acceleration demand is made, the throttle is opened and fuel is supplied to the engine and the engine speed increases. If engine speed is not above a predetermined level, (such as, for example, throttle demand is insufficient to increase engine speed above a predetermined level) the method loops back to step 68. When the engine speed is above a predetermined level, step 72 is determining whether the turbocharger speed is above a predetermined level. If yes, then adequate air is being supplied to the engine and the method loops back to step 70. If the determination in step 72 is no, step 74 is determining whether the mass air flow is above a predetermined level. If yes, the method advances to step 76, and diverts excess air flow into the induction storage tank, where it is stored and may be used for charge when boost is low, or when turbo lag occurs, or when spooling occurs. In such an event, the method may return to step 68, and normal engine operation continues.

It should be noted that it is contemplated that a regenerative brake system is employed on one embodiment of the disclosure. During braking events, the energy in braking is at least partially captured and converted to stored air as previously described. In such an event, the regenerative brake system air is stored in the storage tank or in an auxiliary storage tank. It follows that a pressure or temperature sensor may be employed in the storage tank or auxiliary storage tank to monitor pressure or temperature in the tank and prevent overcharging of the storage induct system (storage tank or auxiliary storage tank) with air. This may be achieved by determining the pressure or temperature in the tank, creating data signals indicative of the pressure or temperature, determining whether the pressure or temperature is above a predetermined level, and either venting the air to the atmosphere in the case of the turbo charger, or disengaging regenerative brake system.

In the event at step 74 that mass air flow is not above a predetermined level, such as during turbo lag, spooling or when additional boost is required, step 78 is releasing stored air from the storage system back into the turbo charger to facilitate the turbo speed reaching or exceed the predetermined level thereby ensuing mass air flow is above a predetermined level during periods of turbo lag or boost demand. Once the turbocharger lag period is expired and the turbocharger spools upon acceleration to the proper speed and the proper air charge is being induced into the manifold, the method loops back to step 70 to await another throttle demand request from the operator.

During step 70, the method determines whether engine speed is above a predetermined level. As previously stated, engine speed is affected by throttle demand i.e., whether the throttle is open. In one embodiment of the disclosure, when throttle is open, such as when a demand for acceleration is made and engine speed is below a predetermined level as set for this in step 70, FIG. 4 depicts various actions that occur in the system responsive to throttle demand. Specifically, if the throttle is open, the air bypass control valve 48 is closed, as is and the stored charge control valve 42 on the storage tank is open as well as the stored charge control valve 18 on the auxiliary storage tank. The wastegate 34 opens when boost levels exceed control limits to allow exhaust flow to bypass the turbocharger. Otherwise, the wastegate remains closed while the boost level increases. In addition and if the pressure in the exhaust storage tank 26a or optionally 26b (as seen in FIG. 2) exceeds a predetermined level, the wastegate may open for a predetermined period of time during acceleration to initiate turbine pre spool by diverting pressurized exhaust flow to the turbine. Any predetermined wastegate functionality would be controlled by an electronic controller 58. The stored charge control valve 54 remains closed, and the stored charge control valve 20 on the auxiliary tank remains closed if the intake turbo boost level is at its peak. If it is not at its peak, valve 20 may open to supplement the air charge if the compressed air tank 16a or optionally 16b, pressure exceeds a predetermined boost level.

In the event the throttle is not open, the wastegate, auxiliary stored charge valves and the stored control valve 42 are closed. The stored control valve 54 from the regenerative braking air compressor outlet is open while the vehicle is in motion and undergoing braking. In addition, it is contemplated this valve may be opened if the vehicle is coasting and if braking is predicted or experienced. In addition, valve 48 is open to bypass air intake while the charge is stored in the intake tube.

Further enhancements could be incorporated into the system to further capture what would otherwise be wasted exhaust energy. An enhancement could include a method of collecting bypassed exhaust flow from the wastegate into a different auxiliary tank 26a or optionally 26b in a manner in which it could be recycled and diverted to the inlet of the turbocharger exhaust turbine in a controlled manner via the wastegate 34. The diverted flow could be used to initiate exhaust turbine rotation upon acceleration, thus further reducing lag.

Instead of bypassing the exhaust to the atmosphere as is sometimes customary in race applications or bypassing to the exhaust system as is found in conventionally applications, the wastegate 34 would be used to direct the bypassed exhaust flow to the auxiliary tank 26a or optionally 26b and also to allow it back into the exhaust stream in a controlled and predetermined manner.

The same manner in which the wastegate is normally controlled could be used to divert pressurized exhaust to the inlet of the turbocharger exhaust turbine. This could be accomplished by controlling the opening of the wastegate once a need for increasing boost arises and assuming that a number of conditions can be satisfied. Such conditions would include whether or not the vehicle is in motion and accelerating, and whether the intake manifold is low enough for there to be a benefit of re-spooling the turbocharger.

While an embodiment has been described as set forth above, it is understood that the words used herein are words of description, and not words of limitation. Various modifications will be apparent to those skilled in the art without departing from the scope and spirit of the invention without departing from the invention as set forth in the appended claims.

What is claimed as new and desired to be protected by Letters Patent of the United States is:

1. A method to operate an internal combustion engine having an electronic controller with memory and operating instructions within said memory and a turbocharger, comprising:
determining whether engine speed is above a predetermined level;
determining whether said turbocharger is operating above a predetermined speed;
determining whether mass air flow is above a predetermined level;
releasing stored air charge from an air induction storage system to the turbocharger when mass air flow is below a predetermined level until said turbocharger speed is above a predetermined level.

2. The method of claim 1, wherein determining engine speed is made by determining throttle demand position.

3. The method of claim 1, further including diverting excess air flow to the air induction storage system when mass air flow is above a predetermined level.

4. The method of claim 1, further including operating a regenerative brake system and storing air in said air induction storage system during coasting or braking events.

5. The method of claim 1, further including determining pressure or temperature in said air induction storage system; determining whether the pressure or temperature is above a predetermined level, and either venting the air to the atmosphere in the case of the turbo charger or disengaging regenerative brake system.

6. The method of claim 1, further including diverting exhaust gas flow to the turbocharger when the turbo charger speed is below a predetermined level.

7. The method of claim 6, further including diverting exhaust gas flow around the turbocharger when turbocharger speed is above a predetermined level and said air induction storage system is above a predetermined pressure or temperature.
